(19) United States
(12) Patent Application Publication
(10) Pub. No.: US 2016/0127325 A1
(43) Pub. Date: May 5, 2016

(54) SCRAMBLING BUSINESS DATA

(71) Applicants: Jens Odenheimer, Karlsruhe (DE); Peter Eberlein, Malsch (DE)

(72) Inventors: Jens Odenheimer, Karlsruhe (DE); Peter Eberlein, Malsch (DE)

(21) Appl. No.: 14/526,520

(22) Filed: Oct. 29, 2014

(51) Int. Cl. H04L 29/06; G06F 17/30; G06Q 10/06

(52) U.S. Cl. CPC H04L 63/0428; G06Q 10/06; G06F 17/30864

(57) ABSTRACT

Methods and system are disclosed that scramble business data before transferring to a test environment. In one aspect, a business data scrambling logic may detect a transfer of the business data from a proprietary database (e.g., source database) to another database (e.g., target database) in test environment. The business data scrambling logic may determine metadata associated with the business data stored in source tables in the source database. Based on the metadata, the columns in the source tables including indicia may be identified. For the identified columns, alias values and associated hash codes may be generated. In the target database, target tables may be generated upon transferring the business data from the source database to the target database. The target tables may include values (e.g. actual values) and alias values associated with the business data. The alias values may represent scrambled business data.

### BACKGROUND

Information in test and development systems is often masked to protect data from inappropriate visibility. Typically, masking techniques may include encrypting the data resulting in random strings of characters (e.g., combination of alphabets, numerals, special characters, etc.). The data generated by using such encrypting techniques may be inconsistent and may defeat the purpose of usability. Generating encrypted data including information that looks similar, but completely unrelated to the real details may be challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating environment to scramble business data, according to an embodiment.

FIG. 2 is a flow diagram illustrating process to scramble business data, according to an embodiment.

FIG. 3 is a block diagram illustrating a source table residing in a source database, according to an embodiment.

FIG. 4 is a block diagram illustrating a mapping table residing in a source database, according to an embodiment,

FIG. 5 is a block diagram illustrating a target a e residing in a target database, according to an embodiment.

FIG. 6 is a block diagram of a computer system, according to an embodiment.

### DETAILED DESCRIPTION

Embodiments of techniques related to scrambling business data are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Advancements in engineering and technology have increased a demand for systems and applications that work coherently using converged infrastructure. The computing resources, frameworks, infrastructure, etc. (e.g., memory, storage, data processors, etc.), may be shared to increase the functional coherency to offer shared services. Distributed computing (e.g., cloud computing or “the cloud”) environments may provide a network of: remote servers to support data processing tasks, centralized data storage, computing services, computing resources, etc., that may work coherently to achieve a desired business objective.

Cloud computing environments may be deployed as private cloud, hybrid cloud, public cloud, etc. Private cloud is cloud infrastructure that is operated solely for a single organization that can be managed internally or by a third-party and hosted either internally or externally. Public cloud offers the services that may be rendered over a network that is open for public use. Public cloud services may be free of charge or offered on a pay-per-usage model. Hybrid cloud is a composition of two or more clouds (private or public) that remain distinct entities but are bound together, offering the benefits of multiple deployment models. The differences in the public and the private cloud architecture may be insubstantial, but security consideration may be substantially different for services (applications, storage, etc.) when communication is effected over a non-trusted network.

In an embodiment, business data associated with an organization and stored in different databases may be proprietary and may include information that may be classified as confidential or sensitive. From business security perspective, such business data must be protected. Organizational data security policies and legislative authorities may enforce a obligation that may require protection of such business data. In a production environment (e.g., within the organization), such business data may be protected by restricting access and enforcing strict controls using user interfaces that present a managed view of information. In test and development environment (e.g., outside the organization), access to the business data may be unrestricted. In such a scenario, the data security policies may enforce that the business data classified as sensitive or confidential needs to be scrambled.

In an embodiment, scrambling the business data may include randomly replacing the contents of a column of business data with information that looks similar, but is unrelated to real details. Such a technique may be referred to as substitution, where the values (e.g., actual values or original values) associated with the business data are replaced or substituted with alias values, in an embodiment, generating the alias values may be based on business logic that may comply with the business requirements. By way of example, the alias values may be generated so that the structure and data type associated with the business data is consistent. The scrambled business data includes the alias values that may be humanly readable and protects the sensitive information. End users consuming such business data may not interpret whether the business data corresponds to real details or scrambled information.

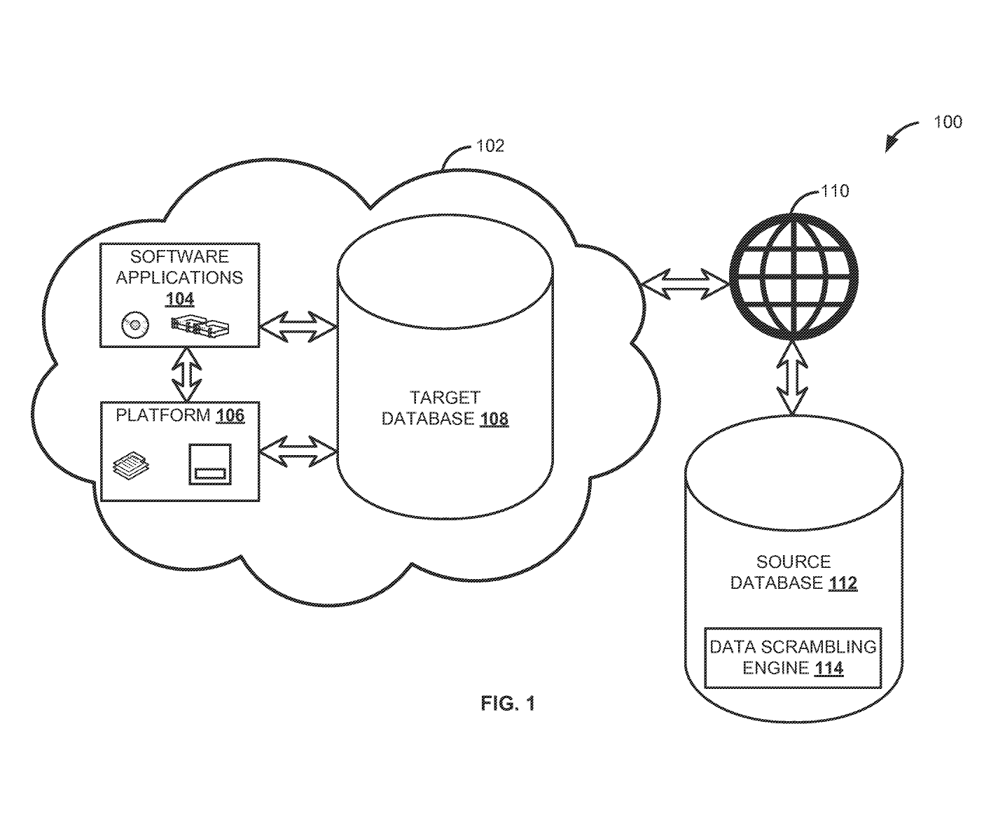

FIG. 1 is a block diagram illustrating environment 100 to scramble business data, according to an embodiment. By way of illustration, FIG. 1 shows a distributed computing environment 102 including computing resources, such as servers, storage devices, computers, networking devices, central processing unit, random access memory, etc. The computing resources may be interconnected over communication network 110 (e.g., Internet). In an embodiment, distributed computing environment 102 may correspond to a cloud computing environment that may provide means to run programs and applications simultaneously on multiple computers. The distributed computing environment 102 may provide software applications 104 and platform 106 as a service to end users. The software applications 104 and platform 106 may be in communication with storage devices (e.g., target database 108).

By way of illustration, FIG. 1 shows a source database, 112, in communication with target database 108 over communication network 110. In an embodiment, the target database 108 may be deployed in distributed computing environment 102, while source database 112 may be deployed on premise. The source database 112 includes data scrambling engine 114 and stores business data. The business data may be structured or unstructured data and may be stored in source database 112 in multiple source tables in rows and columns (not shown). The business data stored in source database 112 may be associated with an organization and may include information related to employees, customers, finance, sales, human resource, etc. Some of the business data may include information that may be classified as sensitive or confidential information.

For example, consider that the organization requires a software application for managing human resource business data to be deployed in distributed computing environment 102. The organization may consider implementing such software application developed by a software development vendor. The software development vendor may set up a test and development environment to deploy the software application in distributed computing environment 102. In this scenario, the software development vendor may develop and test the functional aspects of the software application using the business data associated with the human resource. By way of example, the business data associated with the human resource may include an employee number, first name, last name, a residential address, a social security number, interests, hobbies, etc. Some of the business data may include information that may be classified as sensitive or confidential information and may need to be protected. The organization may consider scrambling the business data by randomly replacing the contents of a column including sensitive information with information that looks similar, but is unrelated to real details.

In an embodiment, consider that the business data associated with the organization may be stored in a proprietary database (e.g., source database 112). To test the functional aspects of the software application, the business data including the sensitive information may be transferred to another database (e.g., target database 108) that may be maintained by the software development vendor. The source database 112 may have similar (e.g., identical) structural attributes to the target database 108. Upon initiating a transfer, data scrambling engine 114 in source database 112 may detect the data transfer. Data scrambling engine 114 may be configured to determine metadata, attributes and attribute values (e.g., actual values or real details) associated with the business data. Upon determining the metadata., data scrambling engine 114 may determine the columns associated with the source tables in source database 112.

In an embodiment, some of the columns associated with the source tables in source database 112 include business data classified as confidential or sensitive and may be identified or marked with an indicia. The other columns that do not include business data classified as sensitive—may not include the indicia. Data scrambling engine 114 may be configured to determine the columns that include the indicia. Upon determining such columns, data scrambling engine 114 may generate alias values and associated hash codes. The generated alias values and the associated hash codes may be stored in a mapping table in source database 112. The business data that is transferred to target database 108 may include the actual values and alias values. Target tables may be generated in target database 108, when the actual values from the columns that include the indicia are substituted by the alias values. The target tables may store the actual values and the alias values in rows and columns. The alias values stored in the target database may represent scrambled business data.

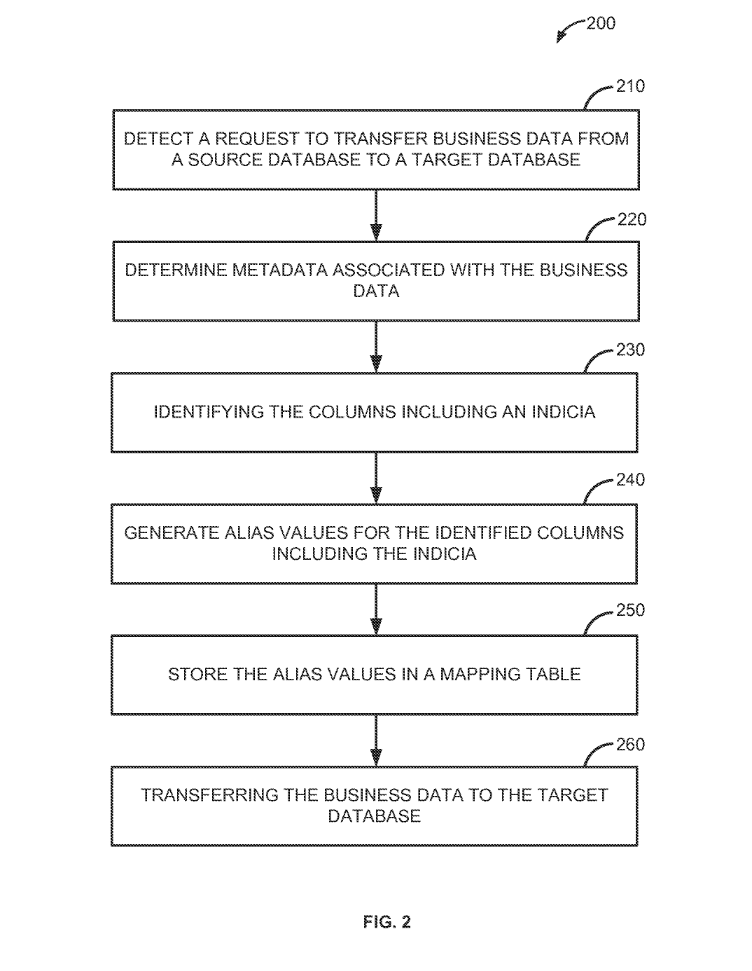

FIG. 2 is a flow diagram illustrating process 200 to scramble business data, according to an embodiment. Process 200, upon execution, scrambles business data associated with an organization. The business data may be stored in multiple data stores that may be geographically distributed and may be accessed by systems and applications of the organization over a network. The business data may be structured or unstructured and stored in data structures (for e.g., tables, flat files, etc.) in the data stores. In an embodiment, a data store may correspond to a web-based database, a relational database, hierarchical database, network database, object oriented database, an in-memory database, a virtual private database, a real-time database, etc.

In an embodiment, the business data stored in the data store may include information related to: human resource data associated with the employees, customers, sales, financial information, service level contracts and agreements with the customers, etc. Some of the business data may be classified as sensitive information or confidential information. By way of example, the human resource data associated with the employees may include employee number, first name, last name, residential address, social security number, interests, hobbies, etc. Some of the information associated with the business data related to the human resource may be classified as sensitive or confidential information.

In an embodiment, the access to such sensitive information may be protected by access control mechanisms within the organization. However, when such business data needs to be shared with a third party vendor or development vendors, the sensitive information may need to be scrambled for protecting it. By way of example, consider that the business data was to be shared with a software development vendor for testing systems or applications. In such a scenario, the sensitive information may be protected by scrambling the business data. In an embodiment, the business data may be scrambled by generating alias values based on business logic (e.g., business data scrambling logic). The business data scrambling logic may include determining structure and data type associated with the business data and generating alias values associated with the business data, that are consistent in structure and data type. The generated alias values may be linked with hash codes that may be generated, e.g., using a one-way hash function.

For example, consider that “XYZ, Inc.” is a customer of “ABC, Inc.” and has a business requirement for developing a software application for human resource management. The business requirement involves deployment of the software application in a distributed computing environment (e.g., a cloud computing environment). Consider that, “XYZ, Inc.” approaches “ABC, Inc.” with such business requirement, and consider that “ABC, Inc.” assigns a team for developing the software application. Upon developing the software application, the team from “ABC, Inc.” may want to test the functional aspects of the software application using business data from “XYZ, Inc.”

Consider that the associated business data may include information related to employee's human resource data. By way of example, such information may include details, such as, an employee number, first name, last name, a residential address, asocial security number, interests, hobbies, employee salary, etc. Some of the business data may include information that may be classified as sensitive or confidential. In this scenario, “XYZ, Inc.” may consider scrambling the sensitive information before sharing the business data with “ABC, Inc.”

For example, consider that the business data associated with “XYZ, Inc.” is stored in a database (e.g., source database). The source database may store the business data in source tables in rows and columns. Some of the columns (e.g., residential address, social security number, employee salary, etc.) from the source tables that include data classified as sensitive information may be identified by indicia. By way of example, the indicia may correspond to primary key columns, foreign key columns, user defined columns, etc. An end user may identify columns including sensitive information and customize such a column to include an identifier (e.g., the indicia). In an embodiment, consider that “ABC, Inc.” requests business data associated with the human resource from “XYZ, Inc.” for testing the software application. Consider that the business data is transferred to a database (e.g., target database) that is accessible by “ABC, Inc.”

“ABC, Inc.” may request the business data to be transferred to the target database. The source database and the target database may have similar structural attributes. In an embodiment, a request to transfer the business data from the source database to the target database is detected, at 210. The business data may include values (e.g., actual values) that may be stored in multiple source tables in the source database. In another embodiment, the business data including values may be stored in data structures, such as, flat files, spreadsheets, etc., in the source database. In an embodiment, the business data stored in the source database may be identified by associated metadata. By way of example, the metadata may include table names; column names; identifiers (e.g., columns including indicia to indicate primary key columns, foreign key columns, columns including business data identified or categorized as sensitive information, etc.); rows including the values of the business data; structure of the business data (e.g., name, address, etc.); data type of the business data (e.g., character, integer, float, date, binary, etc.); association of the business data with data dictionaries, range information associated with the business data, etc.

In an embodiment, the metadata associated with the business data is determined, at 220. Based on the determined metadata, the columns of the source tables including the indicia are identified, at 230. Upon identifying the columns including the indicia, alias values for the identified columns including the indicia, are generated, at 240. (e.g., alias values corresponding to the values (e.g., actual values) stored in the columns that include the indicia are generated). The alias values are stored in a mapping table, at 250. The mapping table may reside in the source database and may include columns storing the alias values and associated hash codes. In an embodiment, the hash codes are unique, generated by a one-way hash function, and are linked with the alias values in the mapping table.

In an embodiment, the business data is transferred to the target database, at 260. Transferring the business data to the target database includes transferring the values (e.g., actual values) stored in the columns that do not include the indicia and scrambled values (e.g., alias values) corresponding to the column that include the indicia. The target tables store the business data (e.g., actual values and the alias values) in rows and columns. The columns (e.g., columns from the source tables) that do not include the indicia are transferred to the target database without scrambling the business data (e.g., for columns that do not include indicia, alias values are not generated and actual values associated with the business data are transferred), while the columns that included the indicia are transferred to the target database, upon scrambling (e.g., for columns including the indicia, actual values associated with the business data are replaced or substituted with alias values) the business data. The alias values may represent the scrambled business data.

In an embodiment, generating alias values may include determining uniqueness (e.g., unique values) of the values (e.g., actual values) associated with the business data. Upon such determination, for each unique value (e.g., each unique value associated with the business data), the hash codes and alias values may be generated. The determination of uniqueness may eliminate the need for generating the alias values and the associated hash codes for the columns that include instances of identical values (e.g., actual values). In an embodiment, the alias values may be generated based on the structure and data type associated with the business data. The alias values may correspond to numeric alias values or text alias values. The text alias values may be generated by referring to data dictionaries and repositories storing such alias values. By way of example, the text alias values may be generated by using internet look-up services (e.g., Internet look-up services, an address look-up service, etc.). In an embodiment, the text aliases may be generated by referring to user defined data dictionaries. In an embodiment, the numeric alias values may be randomly generated. The numeric alias values may be generated based on a range definition or information representing a range of values.

By way of example, the information representing a range of values associated with the business data may include names (for e.g., first name starting with “Bob”, etc.), dates (for e.g., from Jan. 1, 1994 to Jan. 1, 2003), number of employees with an attribute, such as, speaking a language, size of business data (for e.g., 120 Kb to1.5 Gb), etc. In an embodiment, the metadata associated with the business data may be enriched by including such information.

By way of example, consider that the column including indicia is associated with the salary information. Consider that a data cell in such a column in the source table includes the value (e.g., actual value) “$120,000.” The business data scrambling logic may be configured to generate alias value (e.g., numeric alias value) based on range information. For instance, consider that range information is defined as, when salary is in a range (for e.g., $120,000 to $250,000), and then the numeric alias value (e.g., alias value) may be generated as “$150,000.”

For example, consider a column in the source table including the indicia, is associated with employee name. Consider that a data cell in such a column in the source table includes the value (e.g., actual value) “Bob Miller.” The business data scrambling logic for generating alias value (e.g., text alias value) may be configured to connect with the network and refer the internet look-up service or the user defined dictionary. Upon referring to the user defined dictionary, the business data scrambling logic may generate the alias value (e.g., text alias value) as “John Smith.” The above generated alias values (e.g., $150,000 and “John Smith”) may be stored in the mapping table.

For example, consider a column in the source table including the indicia, is associated with an employee location. Consider that a data cell in such a column in the source table includes the value (e.g., actual value) “New York.” The business data scrambling logic may refer to the address look-up service to generate alias value (e.g., text alias value) as “Dallas.” The generated alias value may be stored in the mapping table. In an embodiment, the business data scrambling logic may include business intelligence to determine not only the data type (e.g., string, numeric, alphanumeric, etc.) associated with the business data, but also the nature of information associated with the business data. As explained in the example above, the data scrambling logic may generate alias values (e.g., text alias values) based on the determination of the nature of information associated with the business data (e.g., when value of the business data in the source table with the indicia includes a name (“Bob Miller”), the alias value that may be generated will include a name (“John Smith”); when the value of the business data in the source table with the indicia includes a location (“New York”), the alias value that may be generated will include a location (“Dallas”), etc. In another embodiment, the data scrambling logic may include business intelligence to distinguish between a customer name and an employee name, even when the data fields including the names stores identical values. Such business intelligence may enrich the metadata information associated with the business data.

In an embodiment, before transferring the business data from the source database to the target database, the business data scrambling logic may determine: the columns in the source tables that include indicia; for such columns, the existence of the alias values by comparing with the mapping table (e.g., actual values, alias values and linked hash codes may be compared) and the business data is transferred to the target database. Upon transferring the business data to the target database, target tables in the target database may be generated. For each instance of the unique values (e.g., actual values) in the columns (e.g., columns from the source tables) including the indicia, the existence of the alias value in the mapping table may be determined and the corresponding value (e.g., actual value) may be substituted with the alias values to generate the target tables.

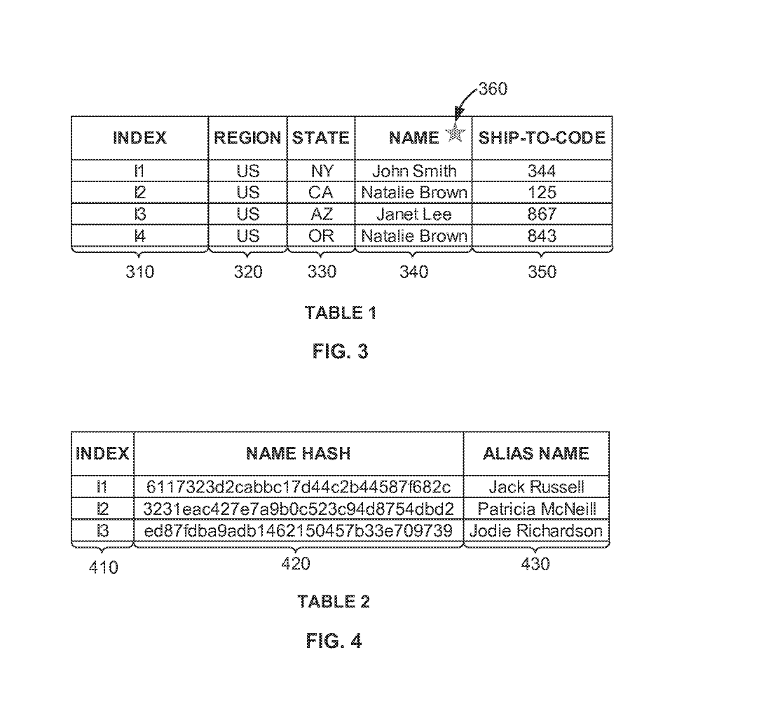

FIG. 3 is a block diagram illustrating a source table residing in a source database, according to an embodiment. By way of illustration, FIG. 3 shows Table 1 exemplarily illustrating columns “INDEX” 310, “REGION” 320, “STATE” 330, “NAME” 340 and “SHIP-TO-CODE” 350. By way of example, the column: “REGION” 320 includes geographical information (e.g., North America; “STATE” 330 includes the names of states in NA (e.g., NY, AZ, CA, OR, etc.); “NAME” 340 includes the name of an individual who is responsible for managing the operations for the region and is a single point of contact; “SHIP-TO-CODE” 350 includes information related to the shipment. By way of illustration, FIG. 3 shows column “NAME” 340 including an indicia 360 (e.g., star sign) indicating that the values (e.g., actual values) are classified as sensitive information.

FIG. 4 is a block diagram illustrating a mapping table residing in a source database, according to an embodiment. By way of illustration, FIG. 4 shows Table 2 exemplarily illustrating columns “INDEX” 410, “NAME HASH” 420 and “ALIAS NAME” 430. In an embodiment, upon identifying a column from a source table including indicia (e.g., 360 at column “NAME” 340 in Table 1 of FIG. 3), the structure and data type associated with the business data may be determined. As explained previously, the alias values (e.g., text alias values, when the identified column is “NAME” 340) and the associated hash codes (e.g., 420 in Table 2) may be generated and stored in a mapping table (e.g., Table 2). In an embodiment, the actual values (e.g., actual values associated with the business data) are not stored in the mapping table. When, the actual values are not stored in the mapping table, the actual values from the source tables and the alias values from the mapping table may be linked using identifiers. In another embodiment, a table (not shown) my be generated and stored in the source database that may include the values (e.g., actual values, for columns that do not include the indicia) and hash codes corresponding to the columns that include the indicia. The table may store the values (e.g., actual values) and the hash codes.

In an embodiment, column “NAME HASH” 420 includes unique hash codes that are generated using a one-way hash function. The column “ALIAS NAME” 430 includes alias values that are generated for the different values (e.g., actual values) in the column “NAME” (e.g., 340 in Table 1). FIG. 4 exemplarily shows that Table 2 includes 3 alias values (e.g., in 3 rows, with indices 11, 12 and 13), while the source table (e.g., Table 1 of FIG. 3) residing in the source database includes 4 values (e.g., actual values, in 4 rows, with indices 11, 12, 13 and 14). As explained previously, the business data scrambling logic for generating the alias values and the associated hash codes determines uniqueness (e.g., unique values) or similarity (e.g., based on predefined thresholds) of the values (e.g., actual values) associated with the business data. Table 1 of FIG. 3 shows that column “NAME” 340 has 2 instances of identical values (e.g., value “Natalie Brown” appears in 2 rows in Table 1, indicated by indices 12 and 14). Based on determination of the uniqueness, the business data scrambling logic associated with generating alias value generates only 1 alias value and associated hash code for “Natalie Brown,” and stores it in the mapping table (e.g., Table 2). Hence, the mapping table (e.g., Table 2) with column “ALIAS NAME” 430 includes 3 alias values (e.g., “Jack Russell”, “Patricia McNeill” and “Jodie Richardson”).

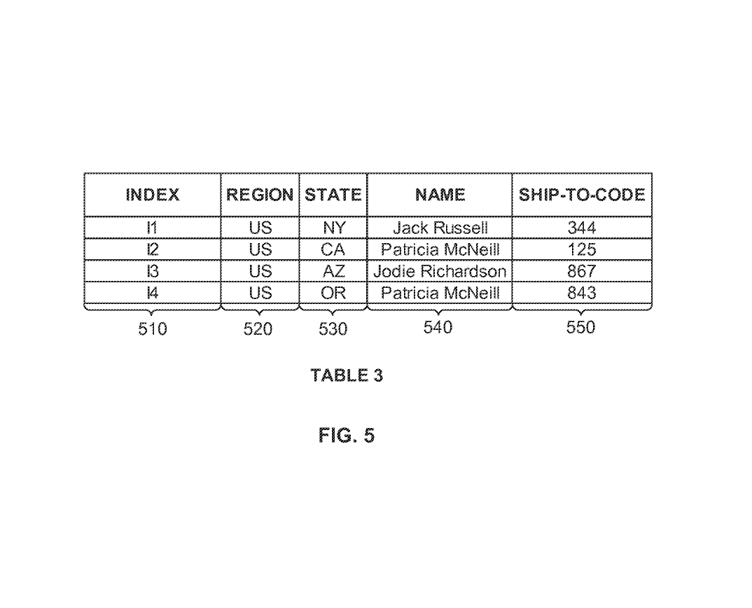

FIG. 5 is a block diagram illustrating a target table residing in a target database, according to an embodiment. By way of illustration, By way of illustration, FIG. 5 shows Table 3 exemplarily illustrating columns “INDEX” 510, “REGION” 520, “STATE” 530, “NAME” 540 and “SHIP-TO-CODE” 550. Column “NAME” 340 of Table 1 in FIG. 3 includes indicia 360 indicating that information in the column “NAME” 340 is sensitive. By way of illustration, FIG. 5 shows Table 3 (e.g., target table) that is generated by substituting the values (e.g., actual values in column “NAME” 340 from Table 1 in FIG. 3) with the alias values (e.g., alias values “ALIAS NAME” 430 from mapping (table, Table 2 of FIG. 4). The target table (e.g., Table 3) may reside in the target database and store the actual (e.g., “REGION” 520; “STATE” 530 and “SHIP-TO-CODE” 550 in Table 3) values and the alias values (“NAME” 540 in Table 3). The alias values represent the scrambled business data.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one of more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be tangible and a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

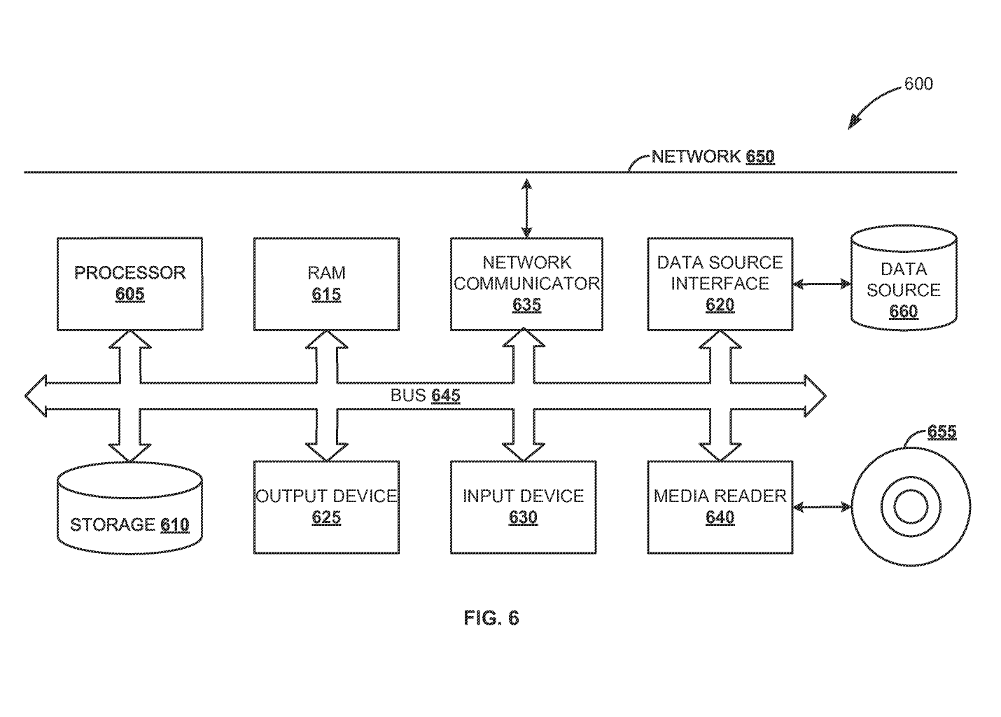

FIG. 6 is a block diagram of an exemplary computer system 600, according to an embodiment. Computer system 600 includes processor 605 that executes software instructions or code stored on computer readable storage medium 655 to perform the above-illustrated methods. Processor 605 can include a plurality of cores. Computer system 600 includes media reader 640 to read the instructions from computer readable storage medium 655 and store the instructions in storage 610 or in random access memory (RAM) 615. Storage 610 provides a large space for keeping static data where at least some instructions could be stored for later execution. According to some embodiments, such as some in-memory computing system embodiments, RAM 615 can have sufficient storage capacity to store much of the data required for processing in RAM 615 instead of in storage 610. In some embodiments, all of the data required for processing may be stored in RAM 615. The stored instructions may be further compiled to generate other representations of the instructions and dynamically stored in RAM 615. Processor 605 reads instructions from RAM 615 and performs actions as instructed. According to one embodiment, computer system 600 further includes output device 625 (e.g., a display) to provide at least some of the results of the execution as output including, but not limited to, visual information to users and input device 630 to provide a user or another device with means for entering data and/or otherwise interact with computer system 600. Each of these output devices 625 and input devices 630 could be joined by one or more additional peripherals to further expand the capabilities of computer system 600. Network communicator 635 may be provided to connect computer system 600 to network 650 and in turn to other devices connected to network 650 including other clients, servers, data stores, and interfaces, for instance. The modules of computer system 600 are interconnected via bus 645. Computer system 600 includes a data source interface 620 to access data source 660. Data source 660 can be accessed via one or more abstraction layers implemented in hardware or software. For example, data source 660 may be accessed by network 650. In some embodiments data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML, data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following, claims, which are to be interpreted in accordance with established doctrines of claim construction.

What is claimed is:

1. A computer implemented method to scramble business data, comprising:
detecting a request to transfer business data from a source database to a target database, the source database including a plurality of columns associated with one or more source tables that store a plurality of values associated with a business data;
determining metadata associated with the business data;
based on the metadata, identifying one or more columns from the plurality of columns, including indicia;
a processor of a computer generating one or more alias values for one or more values of the identified one or more columns including the indicia, the one or more alias values representing scrambled business data; and
transferring the one or more alias values and at least one value associated with the business data, stored in at least one column of the plurality of columns, other than the identified one or more columns including the indicia, from the source database, to one or more tables in the target database.

2. The computer implemented method of claim 1, wherein generating the one or more alias values, comprises:
determining a uniqueness associated with the one or more values in the identified one or more columns including the indicia; and
based on the determination, generating one or more numeric alias values and one or more text alias values corresponding to the one or more values identified one or more columns including the indicia.

3. The computer implemented method of claim 1, wherein transferring the one or more alias values and at least one value associated with the business data, comprises:
upon identifying the one or more values in the one or more columns including the indicia, determining an existence of the one or more alias values from a mapping table, wherein the mapping table stores the one or more alias values; and
upon determining the existence of the one or more alias values in the mapping table, substituting the one or more values in the one or more columns including the indicia with the one or more alias values to generate the one or more target tables.

4. The computer implemented method of claim 1, further comprising: identifying a structure and a data type associated with the business data.

5. The computer implemented method of claim 1, wherein the one or more alias values are associated with one or more hash codes that are generated using a one-way hash function.

6. The computer implemented method of claim 1, wherein the source database and the target database include identical structural attributes.

7. The computer implemented method of claim 1, wherein the metadata associated with the business data corresponds to information including one or more primary key columns, one or more foreign key columns and one or more user defined columns.

8. The computer implemented method of claim 7, wherein the one or more values associated with the business data stored in the one or more primary key columns, the one or more foreign key columns, and the one or more user defined columns represents sensitive information.

9. A computer system to scramble business data, comprising:
a processor; and
one or more memory devices communicatively coupled with the processor and the one or more memory devices storing instructions related to:
detecting a request to transfer business data from a source database to a target database, the source database including a plurality of columns associated with one or more source tables that store a plurality of values associated with a business data;
determining metadata associated with the business data;
based on the metadata, identifying one or more columns from the plurality of columns, including indicia;
generating one or more alias values for one or more values of the identified one or more columns including the indicia, the one or more alias values representing scrambled business data; and
transferring the one or more alias values and at least one value associated with the business data, stored in at least one column of the plurality of columns, other than the identified one or more columns including the indicia, from the source database, to one or more tables in the target database.

10. The computer system of claim 9, wherein generating the one or more alias values, comprises:
determining a uniqueness associated with the one or more values in he identified one or more columns including the indicia; and
based on the determination, generating one or more numeric alias values and one or more text alias values corresponding to the one or more values identified one or more columns including the indicia.

11. The computer system of claim 9, wherein transferring the one or more alias values and at least one value associated with the business data, comprises:
upon identifying the one or more values in the one or more columns including the indicia, determining an existence of the one or more alias values from a mapping table, wherein the mapping table stores the one or more alias values; and
upon determining the existence of the one or more alias values in the mapping table, substituting the one or more values in the one or more columns including the indicia with the one or more alias values to generate the one or more target tables.

12. The computer system of claim 9, further comprising: identifying a structure and a data type associated with the business data.

13. The computer system of claim 9, wherein the one or more alias values are associated with one or more that are generated using a one-way hash function.

14. The computer system of claim 9, wherein the source database and the target database include identical structural attributes.

15. The computer system of claim 9, wherein the metadata associated with the business data corresponds to information including one or more primary key columns, one or more foreign key columns and one or more user defined columns.

16. The computer system of claim 15, wherein the one or more values associated with the business data stored in the one Of more primary key columns, the one or more foreign key columns, and the one or more user defined columns represents sensitive information.

17. A non-transitory computer readable storage medium tangibly storing instructions, which when executed by a computer, cause the computer to execute operations comprising:
detecting a request to transfer business data from a source database to a target database, the source database including a plurality of columns associated with one or more source tables that store a plurality of values associated with a business data;
determining metadata associated with the business data;
based on the metadata, identifying one or more columns from the plurality of columns, including indicia;
generating one or more alias values for one or more values of the identified one or more columns including the indicia, the one or more alias values representing scrambled business data; and
transferring the one or more alias values and at least one value associated with the business data, stored in at least one column of the plurality of columns, other than the identified one or more columns including the indicia, from the source database, to one or more tables in the target database.

18. The non-transitory computer readable storage medium of claim 17, wherein generating the one or more alias values, comprises:
determining a uniqueness associated with the one or more values in the identified one or more columns including the indicia; and
based on the determination, generating one or more numeric alias values and one or more text alias values corresponding to the one or more values identified one or more columns including the indicia.

19. The non-transitory computer readable storage medium of claim 17, wherein transferring the one or more alias values and at least one value associated with the business data, comprises:
upon identifying the one or more values in the one or more columns including the indicia, determining an existence of the one or more alias values from a mapping table, wherein the mapping table stores the one or more alias values; and
upon determining the existence of the one or more alias values in the mapping table, substituting the one or more values in the one or more columns including the indicia with the one or more alias values to generate the one or more target tables.

20. The non-transitory computer readable storage medium of claim 17, storing instructions, which when executed by a computer, cause the computer to further execute operations comprising: identifying a structure and a data type associated with the business data.
